(19) United States
(12) Patent Application Publication
(10) Pub. No.: US 2002/0044641 A1
(43) Pub. Date: Apr. 18, 2002

(54) Telephone with means of memorization or indication of data related to incoming and/or outgoing calls

(76) Inventor: Jean-Marc Wanner, Vendenheim (FR)

Correspondence Address: FULBRIGHT & JAWORSKI, LLP, 666 FIFTH AVE, NEW YORK, NY, 10103-3198, US

(21) Appl. No.: 09/981,518

(22) Filed: Oct. 17, 2001

(30) Foreign Application Priority Data
Oct. 18, 2000 (FR) 00/13364

(51) Int. Cl. H04M 1/00; H04M 3/00

(52) U.S. Cl. 379/350

(57) ABSTRACT

The present invention relates to a telephone comprising a device for memorizing or indicating of data related to incoming and/or outgoing calls. The telephone comprises a detector for supplying a line state signal to memorization or indication device, which memorizes or indicates the data as a function of the state of the line. Thus, the memorized or indicated data take account of calls received on or sent from a secondary telephone.

### BACKGROUND OF INVENTION

The invention is related to a telephone comprising means of memorization or indication of data related to incoming and/or outgoing calls.

Telephones are frequently provided with a memory to store information about incoming and/or outgoing calls.

For incoming calls, the calling number is frequently memorized (if it is transferred on the line) together with the date and time of the call, and if the call was answered, together with the duration of the conversation or more generally the connection. A telephone may also comprise an indicator such as a writing on a screen or a flashing lamp, to show that a call was made and that it was not answered. In this case, the indicator disappears when the user performs a step to show that he become aware of the call.

It is also standard practice to memorize outgoing calls with their dates and durations. In particular, this feature makes it possible to check that invoiced amounts for telephone communications are correct.

This type of telephone is frequently used with other telephones on the same line, in other words with the same number, that may or may not comprise memorization or indication means. For example, the telephone with means of memorizing incoming and/or outgoing calls may be located in the main room of a home, whereas secondary telephones (cordless or with cord) are located in other rooms.

### SUMMARY OF THE INVENTION

The invention is a result of the observation that the memorized or indicated information may not be reliable when a telephone with a memorization or indication device for memorizing or indicating incoming and/or outgoing calls is used with other telephones on the same line. Information about incoming calls is correct only when the call is answered on the main telephone (the telephone on which the memorization or indication means are installed). Similarly for outgoing calls, the memorized information is only correct when these calls are all made from the main telephone and do not terminate on another telephone.

If an incoming call is answered on a secondary telephone, the main telephone will indicate that the call was not answered. If the communication is made on the main telephone and is continued on a secondary telephone, the displayed time will be the time of the communication on the main telephone and not the total time.

When the main telephone is provided with a memorization device for memorizing called numbers and the duration of the communications, and when a call is dialed on the main telephone and is continued on a secondary telephone, the recorded time is the time of the call made starting from the main telephone and does not include the duration of the communication that is continued on the secondary telephone. Furthermore, if an outgoing call is dialed from a secondary telephone, the data for this call are not recorded.

To solve these problems of reliability in memorizing or indicating data related to incoming and/or outgoing calls when a telephone is connected to a line that can be fitted with other telephones called secondary telephones, the invention includes a telephone that comprises:

a device for recording data related to incoming and/or outgoing calls, and

a line state detector,

wherein the recording data about incoming and/or outgoing calls takes into account the signal provided by the line state detector and therefore communications made through the secondary telephone(s) connected to the same line.

Thus in the case of an incoming call, if the main telephone comprises an unanswered indicator, this indicator may be deactivated when the answer is made on a secondary telephone. In accordance with an embodiment of the present invention, the telephone records the duration of incoming and/or outgoing calls, this recorded time is reliable since it takes account of secondary telephones as result of the signal detected by the line state detector.

If the main receiving telephone comprises a memorization device for memorizing the duration of received calls, and if the answer is made on a secondary telephone, the recorded duration will be the duration of the actual communication independently of which telephone(s) was (were) used to answer the call. If the telephone is provided with an unanswered call indicator, means are provided to deactivate this indicator when the line state detector indicates that the line is busy, in other words a call is being answered.

If the telephone comprises a memorization device for memorizing the duration of outgoing calls, possibly with the corresponding numbers when a call is dialed from this telephone, the duration of the call that is recorded corresponds to the total duration, since the end of the call is determined by the line state detector that outputs a signal to stop counting the duration of an outgoing call when the line state detector outputs a signal indicating that the line has changed from the busy state to the ready state.

In one embodiment of a telephone comprising a memorization device for memorizing calling numbers and/or the duration of calling communications, the telephone comprises a called number detector such as a DTMF decoder so that it can provide information about called numbers even when the call is dialed from a secondary telephone.

A called numbers detector can be made using filters and corresponding programming of a processor.

For example, the line state detector can be a detector comprising means of measuring the line voltage or a detector to measure the line activity, in other words a means of measuring the AC signal on the line.

The invention can increase the reliability of data about incoming and/or outgoing calls without complicating the means of making the telephone. In particular, line state detectors are often provided in telephones for other purposes. Furthermore, calling and/or called numbers are usually managed using a microprocessor or micro controller. In this case, the invention requires that the processor is reprogrammed to take account of the line state detector, in particular such that communication durations are the real durations, in other words they are independent of which telephone was used for communication on the line concerned.

In this embodiment, the software to be added to make the invention may be downloaded through the telephone line.

The invention thus usually relates to a telephone comprising a device for memorizing or indicating data related to incoming and/or outgoing calls; this telephone comprises a detector outputting a line state signal to a memorization device or a indication device such that the memorized or indicated data depend on the state of the line.

According to one embodiment, a device for memorization or indication comprise an unanswered incoming call indicator that remains active until an incoming call has been answered, failure to answer the call being determined from the line state signal output by the detector.

In one embodiment, the telephone comprises a device for memorizing communication durations for incoming calls comprising means determining the duration that elapses for these calls between two line state changes. In this case, memorization or indication device may comprise means of memorizing the received numbers.

According to one embodiment, the memorization or indication device memorizes outgoing call durations, thereby determining the duration that elapses for these calls between two line state changes. In this case, the memorization or indication device is operable to memorize called numbers. These numbers may be detected by a detector of the dialed number on the line, such as a DTMF decoder in order to memorize numbers dialed from other telephones connected to the same line.

In one embodiment, the telephone comprises a processor and a device for receiving programming signals over the telephone line to be loaded into the processor memory so that the processor is capable of returning memorized or indicated data as a function of the state of the line.

The invention also relates to a set of at least two telephones including one telephone as described above and one telephone without memorization or indication means.

Other characteristics and advantages of the invention will become clear in the description of some embodiments with reference to the attached drawings in which:

### BRIEF DESCRIPTION OF THE DRAWINGS

FIG. 1 represents a telephone installation comprising a main telephone and secondary telephones,

FIG. 2 is a diagram showing a telephone according to an embodiment of the present invention, and

FIG. 3 is a diagram showing a telephone according for another embodiment of the present invention.

### DESCRIPTION OF THE INVENTION

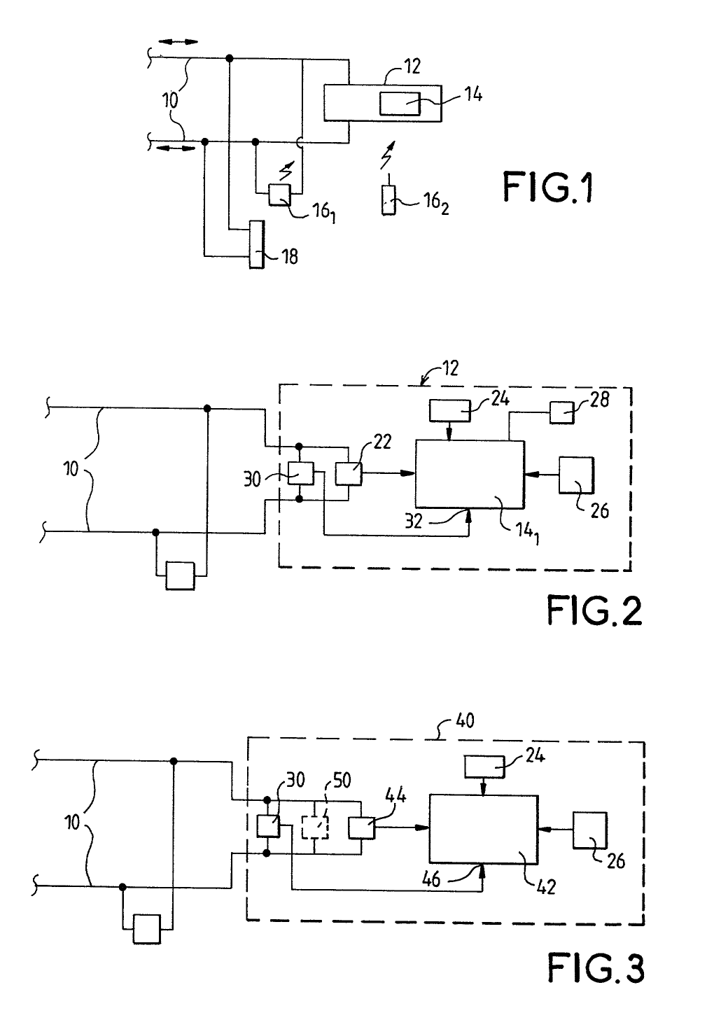

FIG. 1 diagrammatically shows a telephone installation comprising a telephone line 10 to which a telephone 12 is connected, the telephone 12 comprises a memorization device 14 for memorizing data about incoming and/or outgoing calls. In the remaining description, this telephone 12 with the memorization device 14 will be referred to as the main telephone 12. Secondary telephones 16 and 18 are connected in parallel on the same line 10. The main telephone 12 and/or the secondary telephones 16 and 18 may be of the cordless type. For example, telephone 16 is a cordless telephone, in other words there is a base 16₁ connected by wire to the line 10, while the telephone itself 16₂ is cordless and communicates with base 16₁.

The memorization device 14 is capable of performing at least one of the following three functions:

The first function is memorization of incoming calls that had not been answered. In this case, an indicator such as a flashing light signal remains active and must subsequently be deactivated manually.

The second function is an indication of the communication duration for incoming calls, and/or the numbers of these calls (when they are received).

The third function is the communication duration for outgoing calls, and/or the recording of the corresponding numbers.

For each of these three functions, the memorization device 14 does not provide reliable data if the communication is made entirely or partly from a secondary telephone. Thus for the first function, if the main telephone 12 is not picked up, and if only one of the secondary telephones 16 or 18 is picked up to answer an incoming call, then the unanswered incoming call indicator remains active.

When the duration of incoming calls is recorded, this duration only corresponds to the duration of the action taken by the main telephone 12. For example, if the user answers an incoming call on the main telephone 12, and then continues on the secondary telephone 16 or 18 after hanging up the main telephone 12, the recorded time will not be the duration of the call, but it will be the time between when the line is taken and when use of the main telephone 12 terminates.

If an outgoing call is started from the main telephone 12 and terminates on the secondary telephonel6 or 18, and the main telephone was hung up in the meantime, the duration of the outgoing call that will be recorded will be the time corresponding to the time during which the main telephone 12 takes the line 10. Thus, the data output by the memorization device 14 will not be correct. Finally, if an outgoing call is made solely from the secondary telephone 16 or 18, no data will be recorded in the main telephone by the memorization device 14.

The present invention records reliable data on the main telephone 12, even if the secondary telephone 16 or 18 is involved in the incoming and/or outgoing communication.

In the embodiment of the present invention shown in FIG. 2, the telephone 12 comprises a module 14, for memorization and display of data about incoming calls. Therefore, the telephone 12 comprises an incoming calls detector 22, the output of which is connected to an input to module 14₁. The telephone 12 also comprises a time-dater 24 that provides date and duration data to module 14₁. The telephone 12 also comprises a memory 26 providing a telephone directory containing telephone numbers, and other information about the telephone numbers.

The telephone 12 also comprises an unanswered calls notification light 28 that is activated by an output signal from module 14₁. Another type of indication can be provided instead of a light, such as on a display.

According to the present invention, the telephone 12 comprises a line state detector 30 that outputs a signal representative of the line busy state. This signal supplied by the detector 30 is a line state indication and is not an indication that the line is or is not taken by telephone 12. In other words, the detector 30 outputs a line busy signal when any of the telephones connected to the line is picked up. It supplies a line free signal when all telephones connected are hung up.

The line state detector 30 is made in a known manner, and is either of the type that detects the DC voltage of the line 10, or of the type that detects activity on this line 10 (AC signal level).

The signal output by detector 30 is applied to an input 32 of module 14₁ to prevent the light 28 from being activated or lit up when the line changes from a free state to a busy state, in other words when the telephone 12 or a secondary telephone is picked up following an incoming call.

The signal output on the input 32 is also used to determine the real duration of the communication, regardless of which telephone is used to answer it. Thus, the displayed duration will be the time between when the line is taken (line busy start) and when the line is no longer taken (all telephones are hung up).

Under these conditions, if an incoming call is answered by a secondary telephone, the duration of the communication will be recorded in the main telephone 12. Similarly, if the main telephone was used to answer and a secondary telephone was used afterwards, the recorded time will always be the time of the actual communication, in other words the total line busy time.

Conventionally, the time-dater 24 is used to determine communication durations and dates. The directory memory 26 is used in a manner known in itself to memorize the name of the caller when the calling number is already in the directory 26 and when the name is not sent by the telephone exchange on the line.

The telephone 40 shown in FIG. 3 comprises means of memorizing data related to outgoing calls. It comprises a module 42 for memorizing these data and to control their display. The module 42 receives information from a time-dater 24 and from a directory 26 similar to the memory with the same reference number in the embodiment described with FIG. 2.

The dialer 44 on telephone 40 outputs a number signal as an input to module 42. This called number is memorized by the module 42 with the called party's name if this number is in the directory 26.

The time-dater 24 can memorize data or information, such as the called dates and call durations.

According to the invention, the telephone 40 comprises a line state detector 30. This detector is identical to the detector with the same reference in the embodiment shown in FIG. 2. The signal output by the detector 30 is applied to an input 46 of the module 42 such that the data memorized to display outgoing communications information are independent of the telephone (i.e., main or secondary) from which the calls were made or dialed, and are only dependent on the state of the line. Thus, the recorded duration is the duration elapsed between when the line was taken in the first place and when the line was released.

If the call is dialed from the main telephone 40 and is terminated from a secondary telephone, the module 42 records the called number and at the same time the real duration of the communication and not the duration corresponding to the part of the communication done on the main telephone 40 only. If the call is dialed from a secondary telephone, the total duration and the communication may be recorded.

To enable a number called from a secondary telephone to be recorded in the main telephone 40, a variant of this telephone 40 is shown with dashed lines in FIG. 3 comprising a called number detector 50 for detecting a called number on the line 10 from another telephone, i.e., secondary telephone. For example, the detector 50 can be a DTMF decoder.

Regardless of which embodiment is used, the invention makes it possible to make data recorded about incoming and/or outgoing calls dependable, using simple and economic means. When a line state detector 30 is provided in a telephone for a function other than that described for this invention, and when the telephone also comprises a processor, the functions to make the data dependable may be downloaded into the processor in the form of one or more programs. This downloading may be done through the telephone line 10.

The detector 50, particularly a DTMF decoder, can also be made using a processor.

1. Telephone comprising:
a memorization or indication device for memorizing or indicating data related to incoming and/or outgoing calls on a telephone line; and
a detector for outputting a line state signal of the telephone line to the memorization or indication device; and
wherein the memorization or indication device is operable to memorize or indicate the data as a function of the line state of the telephone line, thereby providing reliable data even when calls originate or terminate from or on another telephone on the telephone line.

2. Telephone of claim 1, wherein the memorization or indication device comprises an unanswered call indicator for indicating when an incoming call is not answered as determined from the line state signal.

3. Telephone of claim 1, wherein the line state of the telephone is either a busy state or a free state; and wherein the memorization or indication device is operable to memorize communication times of incoming calls by determining time elapsed between two line state changes for each incoming call.

4. Telephone of claim 3, wherein the memorization or indication device is operable to memorize received numbers of the incoming calls.

5. Telephone of claim 1, wherein the line state of the telephone is either a busy state or a free state; and wherein the memorization or indication device is operable to memorize duration of outgoing calls by determining time elapsed between two line state changes for each outgoing call.

6. Telephone of claim 5, wherein the memorization or indication device is operable to memorize called numbers.

7. Telephone of claim 6, further comprising a called number detector for detecting numbers dialed on the telephone line, thereby memorizing call numbers dialed from other telephones on the telephone line.

8. Telephone of claim 7, wherein the called number tone detector is a DTMF decoder.

9. Telephone of claim 1, further comprising:
a processor having a memory; and
a device for receiving programming signals over the telephone line, the programming signal being downloaded to the memory of the processor; and
wherein the processor is operable to restore the data as a function of the line state of the telephone line.

10. Telephone comprising:
a memorization or indication device for memorizing or indicating data related to incoming and/or outgoing calls on a telephone line; and
a detector for outputting a line state signal of the telephone line to the memorization or indication device; and
wherein the memorization or indication device is operable to memorize or indicate the data as a function of the line state of the telephone line.

11. A multiple telephone set, comprising:
at least one telephone comprising a line detector for outputting a line state signal of a telephone line; and a memorization or indication device for memorizing or indicating data related to incoming and/or outgoing calls on the telephone line;
at least one telephone without the memorization or indication device; and
wherein the memorization or indication device is operable to memorize or indicate the data as a function of the line state of the telephone line, thereby providing reliable data even when calls originate or terminate from or on another telephone on the telephone line.
